(19) United States
(12) Patent Application Publication
(10) Pub. No.: US 2017/0274435 A1
(43) Pub. Date: Sep. 28, 2017

(54) REEL ROTATION DEVICE FOR USE WITH FIBER OPTIC CABLE STORAGE REEL

(71) Applicant: AFL Telecommunications LLC, Duncan, SC (US)

(72) Inventor: Fransisco Adrian Lemus Gomez, Escobedo, Nuevo Leon (MX)

(73) Assignee: AFL Telecommunications LLC, Duncan, SC (US)

(21) Appl. No.: 15/507,015

(22) PCT Filed: Sep. 2, 2015
(86) PCT No.: PCT/US2015/048119

§ 371 Date: Feb. 27, 2017

Related U.S. Application Data
(60) Provisional application No. 62/044,608, filed on Sep. 2, 2014.

(51) Int. Cl. B21C 47/24

(52) U.S. Cl. CPC B21C 47/242; B65G 7/08

(57) ABSTRACT

A device for rotating a reel of fiber optic cable comprising an elongated L-shaped frame with a first side for supporting a reel in its vertical position and a second side for supporting a reel in its horizontal position. Each of the first and the second sides may be supported by casters. When the L-shaped frame is in the vertical or horizontal position orientation, the casters provide a clearance gap between the floor and at least one transition disc which is located at the vertex of the L-shaped frame. The reel of fiber optic cable may be rotated from its vertical position to its horizontal position by adjusting the tension of chains attached to the distal ends of the L-shaped frame, thus shifting the weight from the first-side support casters, onto the transition disc, and onto the second-side support casters.

### FIELD OF THE INVENTION

Embodiments of the present invention relate generally to the manufacture and storage of fiber optic cables and other cable-like products such as conventional wire. More specifically, embodiments of the present invention relate to a device for rotating the orientation of a cable storage reel prior to shipping.

### BACKGROUND

Optical fiber is typically supplied and installed as fiber optic cable. Fiber optic cable includes the actual optical fiber plus the structure in which it is carried and protected during and after installation. In this regard, fiber optic cable generally includes the optical fiber, aramid fibers or other strength members, and an outer jacket. Multiple optical fibers are often combined in a multi-fiber cable, which efficiently carries the requisite number of fibers to the point(s) of applied use. “Fiber optic cable,” as used herein, refers generally to fiber optic cable containing any number of optical fibers and any combination of strengthening or protective members.

As fiber optic cable leaves the production line, it is typically wound on large reels which are placed on respective pallets for shipping and delivery. In this regard, the storage reels are similar to reels used to store other types of cables (including conventional metal wire). Often, these reels can be very heavy and difficult to handle due to the long lengths of cable that they may contain. In some cases, for example, the reels may be loaded on a shipping pallet in a vertical orientation while other situations require the reel to be positioned on a flat pallet in a horizontal position. Moving the reel from the vertical orientation to a horizontal orientation without damaging the reel or the cable it contains can be an arduous task. Moving the reel from place to place in the manufacturing or storage facility can also be difficult.

### SUMMARY

Example embodiments of the present invention recognize and address various considerations of prior art constructions and methods.

One aspect of the present invention provides a reel rotation device comprising an L-shaped frame with a first side for supporting a reel when the frame is in a vertical position orientation and a second side for supporting the reel when the frame is in a horizontal position orientation. A first support arrangement is connected to the first side of the frame and adapted to elevate the reel in the vertical position orientation. A second support arrangement is connected to the second side of the frame and adapted to elevate the reel in the horizontal position orientation. At least one transition element is positioned at a vertex of the L-shaped frame. The reel rotation device may be moved from its vertical position orientation to its horizontal position orientation by transitioning off of the first support arrangement, onto the at least one transition element, and onto the second support arrangement such that the reel itself will be re-oriented from vertical to horizontal.

According to some exemplary embodiments, the first and second support arrangements may provide a clearance gap at an outer surface of the least one transition element when the L-shaped frame is in the vertical position orientation and the horizontal position orientation, respectively. The first and second support arrangements preferably comprise a respective set of support members, such as caster wheels.

Preferably, distal ends of the first and second sides of the L-shaped frame comprise respective lift structures, such as protruding brackets, configured to receive a lifting connection.

The at least one transition element preferably defines an arcuate outer surface. For example, the at least one transition element may comprise first and second transition discs. These transition discs may be attached to outer lateral sides of the L-shaped frame at the vertex thereof.

In exemplary embodiments, the first and second sides of the frame each include a plurality of support bars. For example, the support bars of first side of the L-shaped frame may be supported for rotation to facilitate moving the reel on and off of the reel rotation device.

Another aspect of the present invention provides a method of moving a reel carrying a length of elongate cable between a vertical position and a horizontal position. One step of the method involves providing a reel rotation device having an L-shaped frame with a first side for supporting the reel when the frame is in a vertical position orientation and a second side for supporting the reel when the frame is in a horizontal position orientation. At least one transition element is positioned at a vertex of the L-shaped frame. According to another step, the reel is located on the first side of the L-shaped frame such that it will be situated vertically. The L-shaped frame is moved from its vertical position orientation to its horizontal position orientation by transitioning off of the first support arrangement, onto the at least one transition element, and onto the second support arrangement such that the reel itself will be re-oriented from vertical to horizontal.

According to another aspect, a reel rotation device comprises a frame with a first side for supporting a reel when the frame is in a vertical position orientation and a second side for supporting the reel when the frame is in a horizontal position orientation, the first side and the second side being substantially perpendicular to each other. At least one transition element is positioned at a vertex location between the first side and the second side of the frame, the transition element having an arcuate outer surface. The reel rotation device may be moved from its vertical position orientation to its horizontal position orientation by transitioning off of the first support arrangement, onto the at least one transition element, and onto the second support arrangement such that the reel itself will be re-oriented from vertical to horizontal.

Those skilled in the art will appreciate the scope of the present invention and realize additional aspects thereof after reading the following detailed description of example embodiments in association with the accompanying drawing figures.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is perspective view of a prior art cable shipping arrangement in which the reel is positioned upright (i.e., vertically) on a wooden pallet;

FIG. 2 is a perspective view of a prior art cable shipping arrangement in which the reel is placed on its side (i.e., horizontally) on a wooden pallet;

FIG. 3 is a perspective view of an exemplary reel rotation device which may be constructed in accordance with an embodiment of the present invention;

FIG. 4 is a diagrammatic end view of an exemplary reel rotation device constructed in accordance with an embodiment of the present invention with one transition disc removed for clarity;

FIG. 5 is a perspective view of an exemplary reel and reel rotation device constructed in accordance with an embodiment of the present invention, where the reel is positioned vertically; and

FIG. 6 is a perspective view of an exemplary reel and reel rotation device constructed in accordance with an embodiment of the present invention, where the reel is positioned horizontally.

Repeat use of reference characters in the present specification and drawings is intended to represent same or analogous features or elements of the invention.

### DETAILED DESCRIPTION

Reference will now be made in detail to example embodiments of the present invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations.

Some embodiments of the present invention are particularly suitable for use in packing and shipping fiber optic cable, and the below discussion will describe example embodiments in that context. However, those of skill in the art will understand that the present invention is not so limited. In fact, it is contemplated that embodiments of the present invention may be used in other situations to assist in packing and shipping other types of wire, cable, or reel-packaged products. In this regard, a reel of fiber optic cable is used in discussion for the purposes of explanation only and is not meant to be limiting.

As discussed above, fiber optic cable often comprises many optical fibers and strength members in a protective sheath. After the components are fully encased in the protective sheath, the cable leaves the production line and is fed to a winding machine which winds the desired length of a cable on a reel. During the winding process, the reel is rotated while in the upright (or vertical) position.

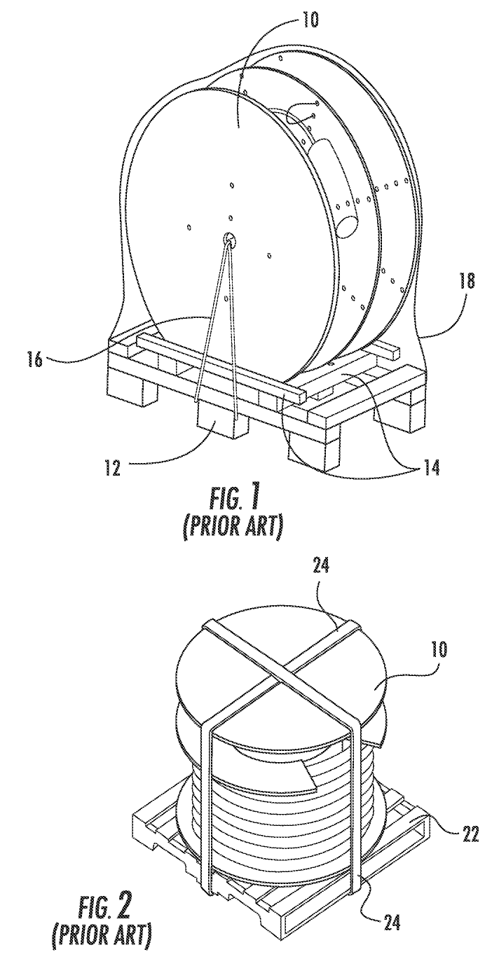

Referring to FIG. 1, the reel 10 of cable is often situated after winding on a support pallet 12 in the vertical position. In this case, the reel 10 remains on pallet 12 in the vertical position for shipping. The top of the vertical support pallet 12 has a bracing structure 14 which helps stabilize the reel 10 in the vertical position. In addition, a securing band 16, fed through the center of the reel 10, is tightly secured to the vertical support pallet 12. Finally, the reel 10 and pallet 12 may be optionally wrapped in shrink wrap 18. Notably, this method of shipping does not require the reel to be re-oriented from its vertical position after winding.

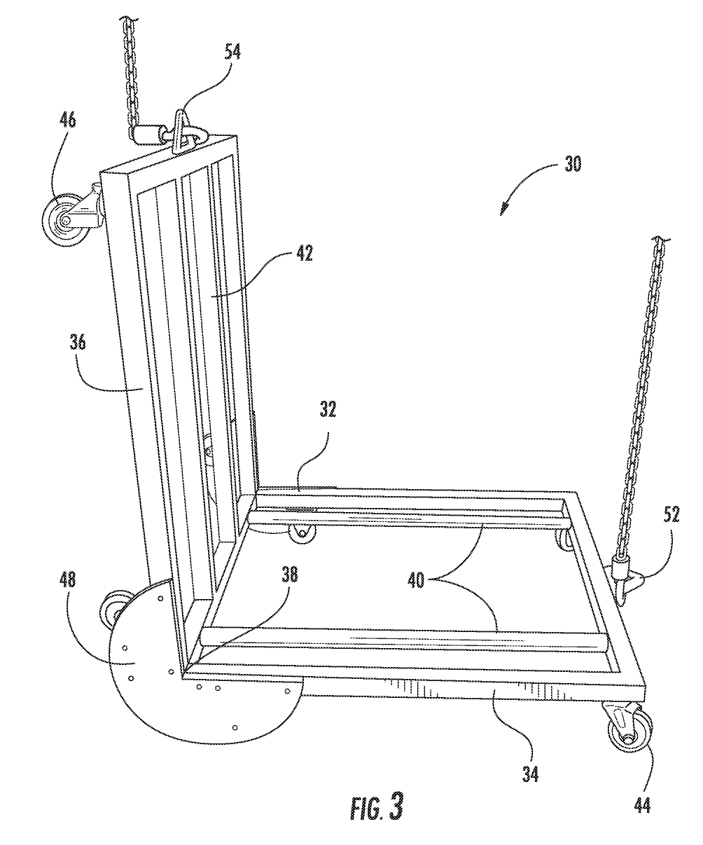

An alternative shipping configuration is shown in FIG. 2. In this configuration, the reel 10 is placed on its side, i.e., in a horizontal position, on a standard flat pallet 22. Securing straps 24 are included to further secure the reel 10 to the pallet 22. It will be appreciated that, when the reel 10 is placed in the horizontal position, the tendency of the reel 10 to roll is eliminated. However, this shipping configuration requires that the reel 10 be re-oriented on its side from the vertical position. As noted above, moving the reel from vertical to horizontal orientation is difficult.

A reel rotation device 30 in accordance with an example embodiment of the present invention will now be discussed with reference to FIGS. 3-6. Such a reel rotation device 30 allows a reel 10 to be rotated (i.e., re-oriented) from its vertical position to its horizontal position in a relatively quick and easy manner. After such rotation, the reel 10 may be easily transferred to a standard pallet 22 for shipping.

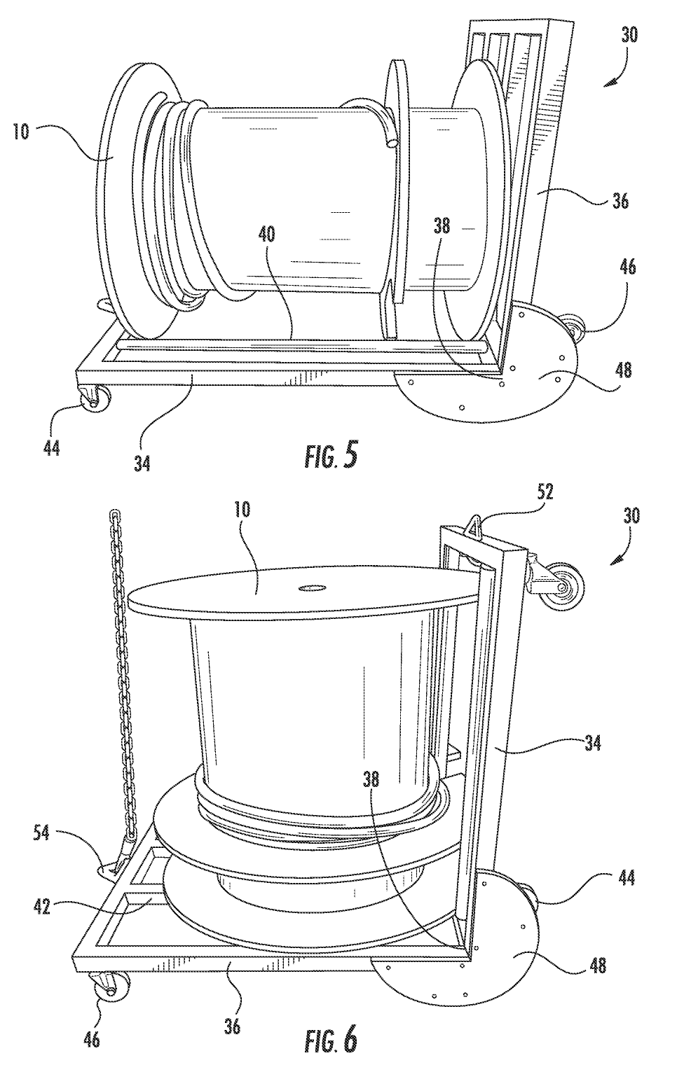

The reel rotation device 30 has an L-shaped frame 32 with a first side 34 and a second side 36 that extend perpendicularly from its vertex 38. The L-shaped frame 32 is preferably made of metal (such as tubular steel), but other suitable rigid materials are also contemplated. The first side 34 is configured to support the reel 10 when it is oriented in its vertical position—e.g., after winding (see FIG. 5). In this embodiment, first side 34 comprises a pair of round cross-section support bars 40 that provide a seat in which the vertically-oriented reel 10 is received. Preferably, support bars 40 may be mounted for rotation in the first side 34 of frame 32, which further facilitates moving reel 10 onto and off of the reel rotation device 30.

The second side 36 of the L-shaped frame 32 is configured to support the reel 10 when it is oriented in its horizontal position (see FIG. 6). Preferably, one or more cross bars 42 extend across the second side 36 frame to provide a flat surface for supporting the bottom of the reel 10.

In this embodiment, suitable transition elements are located at the vertex 38 of the L-shaped frame 32. In the example embodiment shown in FIGS. 3-6, the transition elements comprise partial discs 48 spanning about 270 degrees on the exterior portion of the vertex 38 of the L-shaped frame 32. Transition discs 48 may be attached, for example, on the outer lateral side of frame 32, using suitable fasteners (e.g., screws) or other suitable means of attachment. The arcuate perimeter of transition discs 48 thus provides a pivot for rotating the L-shaped frame 32. The radius of the transition discs and the location of the disc center point (origin) with respect to the vertex 38 can be chosen to facilitate gradual rotation. For example, the disc center point (origin) may be offset from the vertex 38 in some embodiments (as shown).

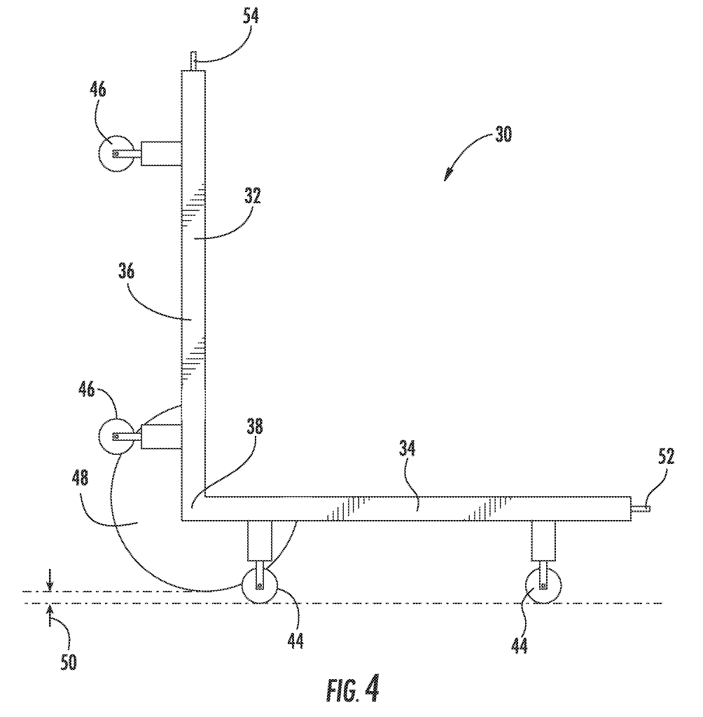

Furthermore, each of the first and second sides 34, 36 has a set of support members, such as support casters 44 and 46, respectively, that elevate each such frame side above the floor (or other ground surface). In this case, four first-side support casters 44 support the weight of the L-shaped frame 32 and reel 10 when in its vertical position. Four second-side support casters 46 support the weight of the L-shaped frame 32 and reel 10 when in its horizontal position. As best seen in FIG. 4, the casters support the frame 32 while providing a clearance gap 50 defined by the radius of transition discs 48 so that the reel rotation device 30 can be easily moved around the production floor. Furthermore, the height of the second side 36 support frame in the horizontal position (i.e., distance from the floor) is preferably substantially the same height as a standard pallet 22. As a result, the reel 10 can be easily slid from the L-shaped frame 32 to the standard pallet 22 for shipping.

As best seen in FIG. 3, the L-shaped frame 32 has lifting brackets 52, 54 on the distal end of both the first and second sides 34, 36 of the L-shaped frame 32, respectively. Lifting rope or chain may be attached to each of the lifting brackets 52, 54 and be used to rotate the reel rotation device 30 from its vertical to horizontal position, and vice versa. As the chain attached to the first-side lifting bracket 52 is raised, the weight of the frame 32 and reel 10 shifts off of the first-side support casters 44 and onto the outer surface of the transition discs 48. As the rotation continues, the chain connected to the second-side lifting bracket 54 supports the weight of the frame 32 as it is transferred from the transition disc 48 onto the second-side support casters 46. By adjusting the tension in the two lifting chains, a controlled rotation of the L-shaped frame 32 and reel 10 can be achieved.

One skilled in the art will appreciate that many modifications to the previously discussed example embodiment are possible and any such modifications are within the scope of the invention. For example, the support members could be support legs instead of casters, and the number of support members could vary depending on load and balance considerations. In such an embodiment, for example, the transition discs could act as permanent support legs such that only support legs on the distal ends of the first and second sides are needed. Furthermore, the lifting brackets can be modified or the lifting mechanism changed depending on the load and lifting requirements.

While one or more example embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A reel rotation device comprising:
an L-shaped frame with a first side for supporting a reel when the frame is in a vertical position orientation and a second side for supporting the reel when the frame is in a horizontal position orientation;
a first support arrangement connected to the first side of the frame and adapted to elevate the reel in the vertical position orientation;
a second support arrangement connected to the second side of the frame and adapted to elevate the reel in the horizontal position orientation;
at least one transition element positioned at a vertex of the L-shaped frame; and
wherein the reel rotation device may be moved from its vertical position orientation to its horizontal position orientation by transitioning off of the first support arrangement, onto the at least one transition element, and onto the second support arrangement such that the reel itself will be re-oriented from vertical to horizontal.

2. A reel rotation device as set forth in claim 1, wherein the first and second support arrangements provide a clearance gap at an outer surface of the least one transition element when the L-shaped frame is in the vertical position orientation and the horizontal position orientation respectively.

3. A reel rotation device as set forth in claim 2, wherein each of the first and second support arrangements comprise a respective set of support members.

4. A reel rotation device as set forth in claim 3, wherein each of the first and second support arrangement comprise at least one wheel.

5. A reel rotation device as set forth in claim 3, wherein each of the first and second support arrangements comprise a plurality of caster wheels.

6. A reel rotation device as set forth in claim 1, wherein each of the first and second support arrangements comprise a respective set of support members.

7. A reel rotation device as set forth in claim 1, wherein distal ends of the first and second sides of the L-shaped frame comprise respective lift structures.

8. A reel rotation device as set forth in claim 3, wherein the lift structures comprise protruding brackets configured to receive a lifting connection.

9. A reel rotation device as set forth in claim 1, wherein the at least one transition element defines an arcuate outer surface.

10. A reel rotation device as set forth in claim 9, wherein the at least one transition element comprises first and second transition discs.

11. A reel rotation device as set forth in 10, wherein the first and second transition discs are attached to outer lateral sides of the L-shaped frame at the vertex thereof.

12. A reel rotation device as set forth in claim 1, wherein the first and second sides of the frame each include a plurality of support bars.

13. A reel rotation device as set forth in claim 12, wherein the support bars of first side of the L-shaped frame are supported for rotation to facilitate moving the reel on and off of the reel rotation device.

14. A method of moving a reel carrying a length of elongate cable between a vertical position and a horizontal position, the method comprising:
(a) providing a reel rotation device having:
an L-shaped frame with a first side for supporting the reel when the frame is in a vertical position orientation and a second side for supporting the reel when the frame is in a horizontal position orientation, and
at least one transition element positioned at a vertex of the L-shaped frame;
(b) locating the reel on the first side of the L-shaped frame such that it will be situated vertically; and
(c) moving the L-shaped frame from its vertical position orientation to its horizontal position orientation by transitioning off of the first support arrangement, onto the at least one transition element, and onto the second support arrangement such that the reel itself will be re-oriented from vertical to horizontal.

15. A method as set forth in claim 14, wherein the L-shaped frame is moved onto the at least one transition element by lifting the first side thereof.

16. A method as set forth in claim 14, wherein the reel is positioned on the first side of the L-shaped frame by rolling in thereon.

17. A method as set forth in claim 14, wherein the first side and the second side of the L-shaped frame each include a respective support arrangement to elevate the first side and the second side above a surface in the vertical position orientation and the horizontal position orientation, respectively.

18. A method as set forth in claim 14, wherein the at least one transition element has an arcuate outer surface.

19. A method as set forth in claim 18, wherein the at least one transition element comprises a pair of transition discs.

20. A reel rotation device comprising:
a frame with a first side for supporting a reel when the frame is in a vertical position orientation and a second side for supporting the reel when the frame is in a horizontal position orientation, the first side and the second side being substantially perpendicular to each other;
at least one transition element positioned at a vertex location between the first side and the second side of the frame, the transition element having an arcuate outer surface; and
wherein the reel rotation device may be moved from its vertical position orientation to its horizontal position orientation by transitioning off of the first support arrangement, onto the at least one transition element, and onto the second support arrangement such that the reel itself will be re-oriented from vertical to horizontal.

21. A reel rotation device as set forth in claim 20, comprising respective first and second sets of caster wheels associated with the first side and the second side, respectively.

22. A reel rotation device as set forth in claim 20, wherein the at least one transition element comprises first and second transition discs.

23. A reel rotation device as set forth in 22, wherein the first and second transition discs are attached to outer lateral sides of the frame.

24. A reel rotation device as set forth in claim 20, wherein the first and second sides of the frame each include a plurality of support bars.

25. A reel rotation device as set forth in claim 24, wherein the support bars of first side of the frame are supported for rotation to facilitate moving the reel on and off of the reel rotation device.
